(19) United States
(12) Patent Application Publication
(10) Pub. No.: US 2005/0204942 A1
(43) Pub. Date: Sep. 22, 2005

(54) System and method of cleaning impression cylinders of a sheet-fed lithographic printing press

(75) Inventor: Daniel A. Bostrack, Pine, CO (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: 3 Magic Beans, LLC

(21) Appl. No.: 11/130,597

(22) Filed: May 17, 2005

Related U.S. Application Data
(63) Continuation of application No. 10/405,942, filed on Apr. 2, 2003.
Application No. 10/405,942 is a continuation of application No. PCT/US01/31093, filed on Oct. 4, 2001.
(60) Provisional application No. 60/238,182, filed on Oct. 5, 2000.

(51) Int. Cl. B41F 35/00

(52) U.S. Cl. 101/425

(57) ABSTRACT

A system and method of cleaning a printing cylinder surface, wherein solid carbon dioxide is incorporated into an air stream, through a nozzle, and impinged on the printing cylinder surface. An exhaust tube may be present to evacuate materials removed by impacting the solid carbon dioxide on the printing cylinder surface. The nozzle and exhaust tube may be reciprocated over the printing cylinder surface to enable a more thorough and efficient cleaning operation. A sensor and control unit may be optionally present. The sensor would sense the thickness of a film being cumulatively deposited on the printing cylinder surface and generate a signal when the film reached a predetermined thickness. The control unit would initiate the cleaning operation in response to the signal from the sensor.

### CROSS-REFERENCES TO RELATED APPLICATIONS

This application is a continuation of U.S. patent application Ser. No. 10/405,942 filed 2 Apr. 2003, which is a continuation of PCT/US01/31093, filed 4 Apr. 2001, which claims priority under 35 U.S.C. § 119(e) to U.S. Provisional Application No. 60/238,182, filed 5 Oct. 2000, each application hereby incorporated by reference.

### BACKGROUND OF THE INVENTION

1. Field of the Invention

This invention relates to systems for cleaning printing presses and, in particular, this invention relates to nonabrasive cleaning methods for cleaning impression cylinders.

2. Background of the Invention

When a lithographic printing press (e.g., sheet-fed) is being operated with radiation curable ink and coating materials, especially UV curable materials, deposits routinely and invariably build on the surface of impression cylinders outside the perimeter of the substrate being printed. These deposits are formed when radiation curable ink (not solvent or water-based) and coating chemicals are irradiated on the surface of the impression cylinder of a sheet-fed lithographic printing press. Due to being cured by radiation and the recurring application of uncured material, the ink and coating materials deposited on the surface of the impression cylinder outside the area covered by the substrate continually increase in thickness. The presence of this coating causes printing problems such as distortion of the blanket and printed image. Further, on a sheet-fed printing machine, a change in substrate length and/or width to a larger size necessitates removal of the aforementioned buildup before the change in size as the thickness of the build-up. If allowed to remain underneath the larger size substrate, the buildup would cause unacceptable printing defects and possible blanket and substrate damage. Moreover, presence of this deposit layer may damage printing blankets when the excessively thick ink/coating buildup is forced through the blanket cylinder/impression cylinder nip under pressure. Thus, diminished printing quality and damage to equipment results from buildup of solidified ink and coating materials. Moreover, during operation, portions of this layer may be broken off or separated, thereby resulting in loose chips and/or particles of cured ink and coating material. These particles may enter the ink train and fountain roller, thereby potentially damaging ink train and fountain roller associated equipment and further diminishing the quality of the printed product.

The conventional method is to remove these ink and coating deposits manually. Usually removal requires hand scrapping the impression cylinder, e.g., with a single-edged razor blade. This manual method is both time consuming and often results in incompletely cleaned impression cylinders. Moreover, down time for cleaning may be excessive and inconvenient as to timing.

### SUMMARY OF THE INVENTION

In one embodiment, the present invention directs pellets or grains of dry ice onto an impression cylinder. The dry ice is entrained in a high velocity stream of compressed air and is directed (impinged) onto the impression cylinder via a nozzle of a cleaning gun. The cleaning gun may be mounted on a carriage, which can traverse across the axial dimension of the impression cylinder while the impression cylinder is rotating, thereby uniformly exposing the entire impression cylinder surface to the stream of dry ice and compressed air. In tandem with the application of the traversing cleaning gun may be a vacuum system to collect sublimated (gaseous) CO₂ and removed ink and coating particles. The removed ink and coating particles may then be transferred for disposal by the vacuum system.

These and other objects, features, and advantages of this invention will become more apparent from the description which follows and when considered in view of the accompanying drawings.

### BRIEF DESCRIPTION OF THE DRAWINGS

FIG. 1 is a side view of a portion of a lithographic printing press and the present cleaning and evacuation system; and

FIG. 2 is a perspective view of the portion of the cleaning and evacuation system of FIG. 1.

### DETAILED DESCRIPTION OF THE INVENTION

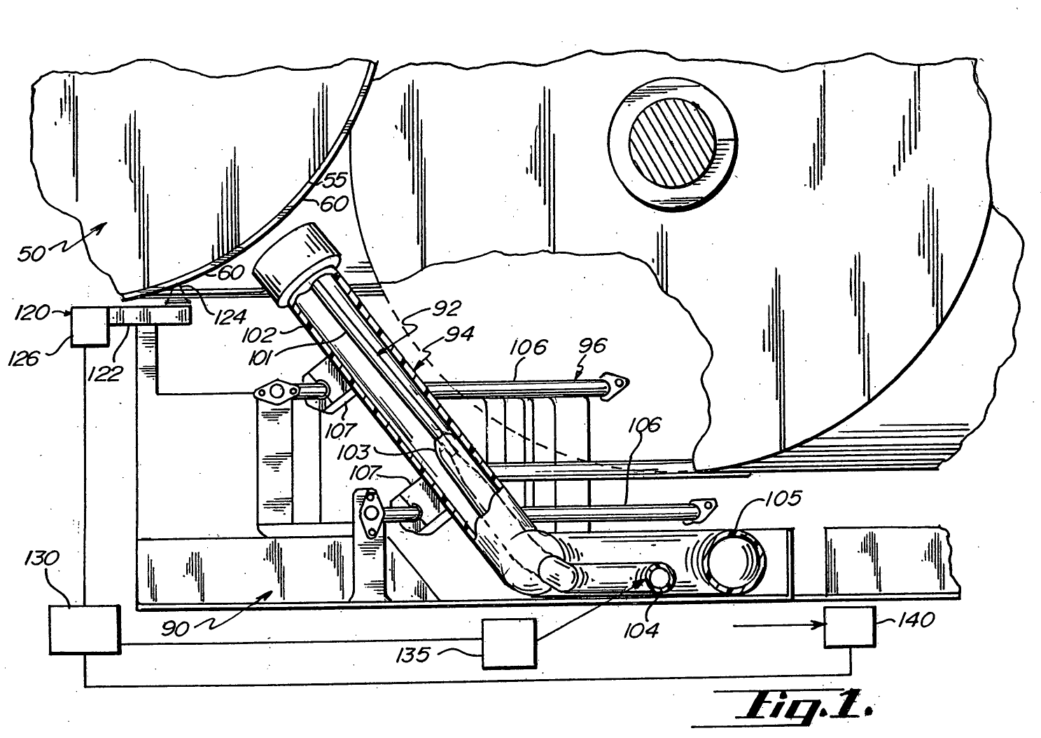

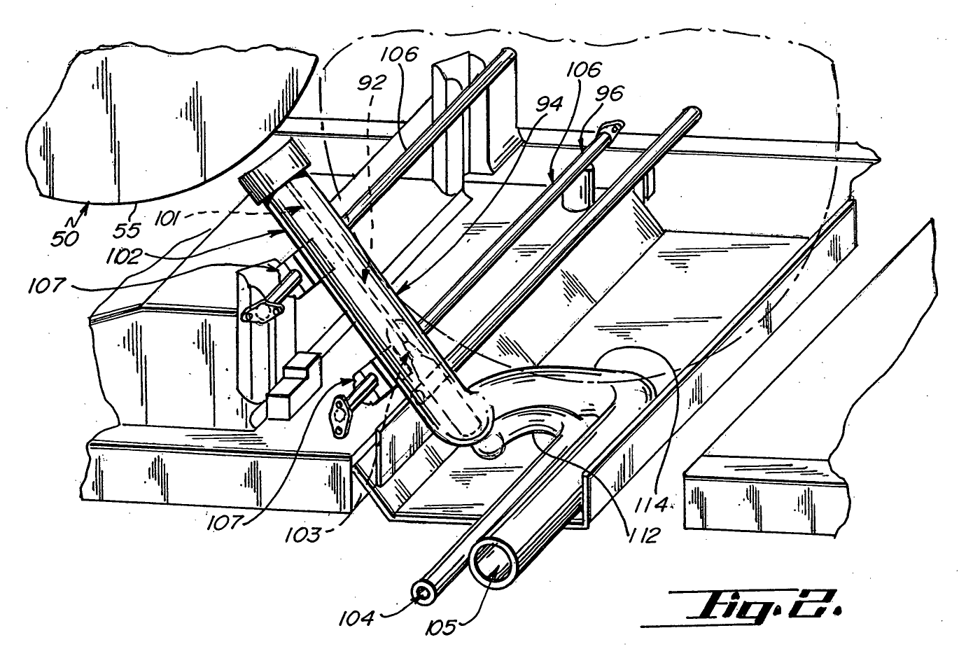

Referring to FIGS. 1 and 2, an impression cylinder 50 of a lithographic printing press assembly is shown. The impression cylinder 50 displays a cylinder surface 55. Shown as 60 is a layer or film of radiation-cured ink and coating materials deposited on the cylinder surface 55 during operation of the lithographic printing press. An embodiment of the present invention is indicated generally at 90 and includes a cleaning materials supply system 92, an evacuation system 94, and a traversal system 96. The supply system includes a dry ice/compressed air nozzle 101, an accelerator 103, and a dry ice/compressed air supply tube 104. The evacuation system includes an exhaust nozzle 102 and an exhaust tube 105. The traversal system includes linear bearings 107 mounted on linear bearing shafts 106.

In operation, an air stream is generated by means known to the art and particulate, nonabrasive cleaning materials such as dry ice (solid carbon dioxide) are introduced into the air stream. Means for generating an air stream include an air compressor (not shown) or fans (not shown). The air tube 104 conducts the air stream-dry ice to a narrowing such as the accelerator 103. At the accelerator 103 the velocity of the air stream-dry ice is increased. The accelerated air stream-dry ice passes through the exhaust nozzle 102 and impinges on, and removes, the layer 60 from the cylinder surface 55. Since the impression cylinder 50 is rotating, one circumferential strip of the layer 60 is removed in this matter. Simultaneously with impacting or impinging the cleaning materials on the cylinder surface 55, a partial vacuum is generated remotely from exhaust tube 105 to suction the sublimated, gaseous carbon dioxide and removed film particles through the exhaust nozzle 102 and exhaust tube 105 to a remote collection facility. As a circumferential strip of the impression cylinder surface and deposit materials are removed as described above, portions of the present apparatus as depicted traverse (e.g., reciprocate) substantially axially across the entire surface of the cylinder via the traversal mechanism 96. Depending upon the size of the cylinder, the speed of rotation, composition and thickness of the deposit layer and other factors known to persons of skill in the art, the traversal speed may be increased or slowed. Thus, it is contemplated that the present invention includes an adjustment to alter the traversal speed as needed. As the present apparatus is being traversed, it is contemplated that the air tube 104 and exhaust tube 105 will contain flexible sections as shown at 112 and 114, respectively, and indicated to accommodate the change in position of the air nozzle 101 and exhaust nozzle 102. It is also contemplated that the tip of the air nozzle 102 may be pivoted to some extent during operation. Pivoting would be advantageous for cleaning irregular surfaces in some situations (see below).

It is also contemplated that a measuring apparatus 120 may automatically determine the depth of the deposit layer 60. In one embodiment, the measuring apparatus 120 includes a device 122 which generates a convergent laser beam 124 or another noncontact proximity sensor capable of measuring desired film thicknesses (e.g., 0.002 inch or less). The device 122 relays the thickness reading to a central sensing unit 126. When the depth of the layer 160 has increased to a predetermined thickness, a signal from the unit 126 may be electrically conveyed to a controller 130. The controller 130 would then initiate generation of the forced air stream and particulate CO₂ by unit 135, generation of a partial vacuum by controller 140, and traversal at a predetermined speed.

The nature of the present pellet/air stream cleaning apparatus is such that it will clean surfaces of other mechanical components as well. One such surface is a gripper mechanism that retains the front edges of the sheets as the sheets travel with (are rotated by) the cylinder. The gripper mechanism resides in a gripper gap, a recessed void in the cylinder. The present cleaning system can clean the gripper gap. Moreover, the present cleaning system can clean irregularly shaped components within or outside the gripper gap, while the cylinder rotates, thereby increasing the service life of these irregularly shaped components by removing abrasive contaminants therefrom. Additionally, the present cleaning device does not need to be retracted to allow for clearance of gripper fingers protruding from the gripper gap and extending above the cylinder surface.

Although the present invention has been described with reference to a preferred embodiment, persons of ordinary skill in the art will recognize that various modifications and changes may be made without departing from the spirit and the scope of the invention. For example, the relative dispositions of the air nozzle 101 and exhaust nozzle 102 may be altered. Moreover, other cleaning materials such as dry air may be used, e.g., solidified nitrogen or other materials which would not react with, or otherwise corrode the impression cylinder surface and which are normally gaseous at ambient room temperatures.

1. A system for cleaning a surface of an impression cylinder of a sheet fed printing press, the system comprising:
a structure for generating an air stream;
a nozzle directing the air stream at the impression cylinder surface;
a supply conveying solid carbon dioxide into the air stream;
a traversal system in mechanical communication with the nozzle and configured to reciprocate the air stream over the impression cylinder surface.

2. The system of claim 1, further comprising an accelerator proximate the nozzle.

3. The system of claim 1, further comprising
a structure for generating a partial vacuum; and
an exhaust tube in fluid communication with the structure for generating a partial vacuum and positioned proximate the impression cylinder surface to convey materials away from the impression cylinder surface.

4. The system of claim 3, in which the nozzle is positioned at least partially within the exhaust tube.

5. The system of claim 1, in which the traversal system is configured to axially reciprocate the airflow over the impression cylinder surface.

6. The system of claim 1, the traversal system comprising a first bearing and a first shaft, the first bearing attaching the first shaft to one of the nozzle and exhaust tube.

7. The system of claim 6, the traversal system further comprising a second bearing and a second shaft, the second bearing attaching the second shaft to one of the nozzle and exhaust tube.

8. The system of claim 1, further comprising a sensor positioned and configured to measure a depth of a film on the impression cylinder surface and generate a film depth reading in response thereto.

9. The system of claim 8, the sensor generating a convergent laser beam.

10. The system of claim 8, further comprising a signaling unit in electrical communication with the sensor.

11. The system of claim 10, the signaling unit receiving the film depth reading from the sensor and generating an initiation signal in response to the film depth reading when the film depth reading indicates a predetermined film depth on the impression cylinder surface.

12. The system of claim 11, further comprising a controller receiving the initiation signal from the signaling unit and initiating generation of the air stream in response thereto.

13. The system of claim 1, in combination with the impression cylinder, the nozzle directing the air stream at a surface of the impression cylinder.

14. A method of cleaning an impression cylinder surface of a sheet fed printing press, comprising:
generating an air stream;
incorporating solid carbon dioxide into the air stream; and
impinging the air stream and solid carbon dioxide on the impression cylinder surface.

15. The method of claim 14, in which the air stream is reciprocally impinged on the impression cylinder surface.

16. The method of claim 14, in which the air stream is axially and reciprocally impinged on the impression cylinder surface.

17. The method of claim 14, in which the air stream is impinged on the impression cylinder surface in response to an impression cylinder surface film depth reading.

18. The method of claim 14, in which the air stream is impinged on the impression cylinder surface in response to an impression cylinder surface film depth reading obtained by directing a convergent laser beam at the impression cylinder surface.

19. The method of claim 14, in which the air stream is impinged on the impression cylinder surface in response to an initiation signal from a signaling unit, said initiation signal generated from the signaling unit in response to a predetermined impression cylinder surface film depth reading.
